(19) United States
(12) Patent Application Publication
(10) Pub. No.: US 2003/0032355 A1
(43) Pub. Date: Feb. 13, 2003

(54) Tougher, softer nonwoven sheet product

(76) Inventors: Joseph R. Guckert, Chester, VA (US); Brian P. Little, Midlothian, VA (US); Robert Anthony Marin, Midlothian, VA (US); Larry R. Marshall, Chesterfield, VA (US); Subhra K. Nath, Midlothian, VA (US); Charles Steven Schwartz, Richmond, VA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/080,802

(22) Filed: Feb. 22, 2002

Related U.S. Application Data
(60) Provisional application No. 60/271,763, filed on Feb. 27, 2001.

(51) Int. Cl. D04H 1/00; B32B 27/14; D04H 5/06; D04H 5/00; B32B 31/00

(52) U.S. Cl. 442/327; 442/409; 428/198; 156/290

(57) ABSTRACT

The present invention relates to film-fibril plexifilamentary sheet products which demonstrate improved balance of toughness and softness combined with improved balance of air permeability and liquid barrier resistance, which are prepared by point bonding a nonwoven sheet on both sides by passing said sheet between embossing rolls at a combination of bonding temperature, pressure and residence time such that the majority of bond points are not bonded to the point of translucency.

### FIELD OF THE INVENTION

The present invention relates to improved nonwoven fabrics especially suitable for use in making protective apparel.

### BACKGROUND OF THE INVENTION

Protective apparel includes gowns, smocks, coveralls and other garments whose purpose is to protect a wearer against exposure to something in the working environment that they have to deal with in the course of their assignment and also includes protective sheet goods such as operating room or other medical drapes. The particular exposure that the wearer confronts in the course of the work assignment impacts the properties required of the fabric. It matters greatly whether the exposure is to wet or dry contaminants or whether the wearer will be exposed to contaminants that are merely undesirable, such as dirt or grease, or actually dangerous to the wearer such as a toxic chemical hazard, or a blood- or other body fluid-borne disease, in the case of a medical worker.

If the hazard is one of liquid exposure then the liquid barrier properties of the sheet become extremely important. Traditionally, liquid barrier is achieved in a plexifilamentary film-fibril sheet product by more bonding of the sheet surface to create a high liquid flow-through resistance. If the hazard is a dry particulate hazard, then the same bonding principle applies, except that one must be careful not to over bond the sheet to the point of forming perforations which would result in a reduced level of barrier.

However, at the same time that the garment is protecting the wearer against the exposure hazard, it is desirable that the garment have sufficient permeability to air and moisture vapor that heat and body moisture can be dissipated through the garment, so that the wearer can maintain a satisfactory thermal comfort level. Bonding of the sheet surface to create high barrier resistance negatively impacts maintaining a high level of air permeability. Also, for wearer comfort, it is highly desirable that the product be soft or capable of being softened by some reasonably economical technique. Again bonding to higher levels has a negative impact on the softness.

The commercial plexifilamentary film-fibril sheet products sold by E.I. du Pont de Nemours and Company of Wilmington, Del., under the trade name of Tyvek® that have been aimed at “soft” structure markets have traditionally been bonded with one side embossed with a “rib” pattern of discrete bond points, such as disclosed in Dempsey and Lee, U.S. Pat. No. 3,478,141, that uses a pair of rolls with sufficient heat and pressure that there are translucent “windows” formed in the fabric directly underneath the bosses on the embossing roll. The other side is embossed over essentially all of the surface with a “linen” pattern that is generated by use of an embossing roll that is engraved with a simulated linen pattern. The linen-by-rib design has subsequently been used for all of the commercial “soft structure” Tyvek® products.

With this commercially used combination of bonding patterns of a point bond on one side and a “linen” pattern on the other, a balance of liquid or solid particulate barrier resistance and strength properties is achieved that is satisfactory for protective garments, particularly for protection from solid particulates such as airborne asbestos particles. However, attempts to soften the product with techniques, such as jets of water, showed a tendency to delaminate the sheet because the linen pattern bonded side is essentially only a surface bond. Milder softening conditions have been used such as button breaking and creping, as disclosed in Dempsey, U.S. Pat. No. 3,427,376, which have resulted in adequate softening for many uses. However, further softening would be desirable for many end uses, particularly in apparel.

Lee and Simpson, U.S. Pat. No. 4,910,075 attempts to resolve this delamination problem in a water jet softened sheet by bonding both sides as a point bonded pattern, with total cross-sectional area at the tips of the bosses at about 4-7% of the sheet area being treated. The sheet produced by the process is bonded to the point of translucency in the 4-7% of the area under the bosses of the embossing roll and then subjected to water jet softening. The final product has a Hydrostatic Head of 20 cm and a Gurley Hill porosity of about 1 sec. This product is adequately soft and breathable and very functional for protective garments for use against dry particulate contaminants, but is only moderately protective against liquids after the aggressive softening action required to soften a structure that had been bonded to the point of translucency.

Further work on point bonding of plexifilamentary film-fibril products is disclosed in Miller, U.S. Pat. No. 4,091,137, which claims a point bonded structure with 8-155 bond points per square cm, that cover 3-25% of the sheet area, where the bond points are formed under sufficient heat and pressure so that they are essentially transparent, with the requirement that the bonded area have an average optical transmission of at least 50%. The aim of this invention was to improve visual uniformity of the product by the contrasting optical transmission between the bonded and unbonded areas.

The need for protective garments that have extremely high liquid spill protection has dramatically increased with the increased exposure of workers to potential liquid chemical hazards, as the complexity of chemical operations continues to expand, and for protection of medical workers against blood- and other body fluid borne-diseases such as AIDS. At the same time these garments need to remain sufficiently soft and air permeable to allow workers to work in them at a reasonable comfort level for long periods of time and they must be sufficiently resistant to tearing and bursting to not be at risk for developing leaks in rigorous use.

### BRIEF SUMMARY OF THE INVENTION

In one embodiment, the present invention relates to a process for preparing a nonwoven sheet comprising point bonding the sheet on both sides by passing said sheet between embossing rolls at a combination of bonding temperature, pressure and residence time such that the majority of bond points are not bonded to the point of translucency.

In another embodiment, the present invention relates to a nonwoven sheet material which has been point bonded on both sides of said sheet, wherein the bond points are not bonded to the point of translucency. The bond points preferably encompass about 10-20% of the area of each side of the sheet.

In another embodiment, the present invention relates to a flash spun film-fibril sheet having a Gurley Hill porosity of less than 4.5 sec and a hydrostatic head of at least 100 cm.

In another embodiment, the present invention relates to a nonwoven sheet made by a process comprising point bonding the sheet on both sides by passing said sheet between embossing rolls at a combination of bonding temperature, pressure and residence time such that the majority of bond points are not bonded to the point of translucency.

### DETAILED DESCRIPTION OF THE INVENTION

A plexifilamentary film-fibril sheet product that has an improved, unique balance of toughness, softness, air permeability and liquid barrier resistance has been developed by point bonding both sides of the sheet product using embossing rolls with bosses of sufficient size to give approximately 10-20% bonded area per side with 50-80 bosses/cm², while bonding at conditions where there is little or no formation of translucent spots at the point of contact of the sheet with the bosses. This product has high liquid barrier and dry particulate holdout while maintaining good breathability and has a 20-30% improvement in toughness over the commercial rib-by-linen bonded Tyvek® while simultaneously being 30-50% softer.

The starting point for the examples of the present invention is the lightly consolidated flash spun polyolefin sheet, in particular a flash spun polyethylene sheet, made by the process of copending application, U.S. Ser. No. 08/914,409. The sheet products for this invention are typically in the basis weight range of 33.9-77.8 g/m² (1.0-2.0 oz./square yard). However, it is expected that other nonwoven fabrics, including but not limited to melt-blown fabrics, melt-spun fabrics and composite fabrics, when subjected to the bonding process of the present invention, will obtain similar qualitative results.

The sheets are bonded by passing them through a pair of heated nips, with an embossing roll having typical point distributions of 50-80 bosses/cm², preferably 60-70 bosses/cm². The dimensions of the bosses are such that the bonded area is from about 10-20%, preferably about 13-17% of the area of the sheet, with the number of bond points in the range of 50-80 per sq. cm., preferably 60-70 bond points per sq. cm. The embossing rolls are typically in the range of 50-60 cm. in diameter and run against an elastomer-coated backup roll of diameter in the range of 45-55 cm., having a Shore A hardness of 50-80, with a preferred Shore A hardness of 65-70.

Line speed of the process can vary from about 256 to 284 m/min, and is preferably maximized for best economy. However, variations in line speed have an effect on residence time, such that line speed should be optimized based upon the desired residence time.

Bonding temperatures of the embossing rolls are typically in the range of 160-190° C. Bonding pressure should be the minimum to give necessary bonding for structural integrity and will vary with roll configuration and backup roll diameter, hardness and coating thickness. Bonding pressures useful in the present invention are from about 5-75 kN/m² of bonded area, preferably from about 20-60 kN/m², more preferably from about 38 to about 50 kN/m², but is typically less than about 50 kN/m² of bonded area (7.15 psi of bonded area). Once the product has been embossed on both sides by this process, the sheet is then mechanically softened using engaged pin rolls.

The process disclosed in Miller, U.S. Pat. No. 4,091,137, describes the use of a rubber backup roll with a surface hardness greater than 70 Shore D (preferably 80-90 Shore D), and an embosser roll loading in the range of 90 to 170 PLI (pounds per linear inch), preferably 120-130 PLI. The backup roll is required to be of said hardness in order to create a product with an average optical transparency of 50%. In order to achieve such optical transparency, it is necessary to use high pressures over a small contact area (‘footprint’) which maintains high pressure per bonded area of the embossed pattern. Example V of Miller discloses that a product created with a backup roll as soft as 60 Shore D (>100 Shore A) fails marginally to meet requirements of the Miller invention.

In contrast, according to the process of the present invention, a much softer backup roll of 60-70 Shore A is employed, in order to reduce the pressure applied from each point of the embossed pattern. (A hardness of 60-70 Shore A is equivalent to 16-22 Shore D hardness, higher values representing harder rubber compounds). The softer backup roll used according to the present invention enables improved bonding by reduction of the pressure applied by the bosses of the mating point bonding roll.

The residence time between any individual boss and the fabric should be less than about 55 milliseconds, preferably between about 3 and 30 milliseconds, more preferably between about 5 and 10 milliseconds.

In order to calculate the residence time, the contact length in the nip region between the embosser roll and rubber backup roll is needed. From the contact length, or “footprint”, the calculation for residence time can be found by the following:

Distance=rate*time

Time=distance/rate

Therefore,

Residence time=footprint/line speed.

This combination of process and apparatus improvements results in better point bonding according to the present invention, enabling point bonding such that the majority of bond points, and preferably all of the bond points, are not bonded to the point of translucency.

The film-fibril sheets formed according to the present process have an unusual combination of properties, a unique balance of toughness, softness, air permeability and liquid barrier resistance. The inventive film-fibril sheets have improved liquid barrier properties, as measured by the Hydrostatic Head of at least about 100 cm, preferably at least about 110 cm, combined with improved air permeability, as measured by the Gurley Hill porosity of less than about 4.5 sec, preferably no greater than about 4 sec. Further, the Handle-O-Meter softness of the film-fibril sheets of the present invention is no greater than about 12 grams. Additionally, the film-fibril sheets of the present invention have unusual toughness, as measured by the work to break, considering the softness and other properties of the sheets. The work to break in the machine direction (MD) of the inventive sheets is at least about 5 N-cm (4.4 in-lbs), preferably about 5.65 N-cm (5 in-lbs), more preferably about 6.2 N-cm (5.5 in-lbs).

The products' ability to resist surface abrasion is particularly advantageous to apparel applications or other applications where the surface fiber stability is of value. It is preferred that the nonwoven sheets of the present invention have a resistance to surface abrasion of greater than 10 strokes, as measured by A.A.T.C.C. Crockmeter, as described above.

The point bonds of the sheets according to the present invention appear to form “ribs” that run in the machine direction of the sheet. The examples of the present invention set forth below are point bonded in a rib-by-rib pattern, i.e. rib bonded on both sides of the film-fibril sheet. It is believed that any of the number of conventional point bonding patterns will be effective to obtain the benefits of the present invention, when used according to the process disclosed herein.

### TEST METHODS

The critical parameters used to characterize this invention include the following tests:

WORK TO BREAK (WTB) of the sheet product is a measure of the toughness or resistance to tearing and puncture of the sheet and is determined by measuring the area under the stress-strain curve. A sample size of 2.54×20.32 cm. (1×8 inches) is mounted in a CRE Instron Tensile Tester. A crosshead speed of 5.08 cm/min (2 inches/min.) is necessary with a minimum of 5.08 cm. (2 inch) clamp width and a gage length of 12.7 cm. (5 inches) to generate a stress-strain curve of the sample. The samples are measured in the machine direction of the product. A product that is tougher will yield a higher work to break value. The test follows ASTM D 5035.

HYDROSTATIC HEAD (HH) is a measure of the resistance of the sheet to penetration by liquid water under a static load. A 17.78 cm. by 17.78 cm. (7 inch by 7 inch) is mounted in a SDL 18 Shirley Hydrostatic head tester (manufactured by Shirley Developments Limited, Stockport, England). Water is pumped against one side of a 102.6 sq. cm. section of the sample at a rate of 60±3 cm/min. until three areas of the sample are penetrated by the water. The hydrostatic head is measured in inches, converted to SI units and reported in cm. of water. The test generally follows ASTM D 583 which was withdrawn from publication in November, 1976. A higher number indicates a product with greater resistance to liquid passage.

GURLEY-HILL POROSITY (GH) is a measure of the permeability of the sheet material for gaseous materials. In particular, it is a measure of how long it takes a volume of gas to pass through an area of material wherein a certain pressure gradient exists. Gurley-Hill porosity is measured in accordance with TAPPI T-460 OM-88 using a Lorentzen & Wettre Model 121D Densometer. This test measures the time for 100 mL of air to be pushed through a 28.7 mm diameter sample (one square inch) under a pressure of approximately 1.21 kPa (4.9 inches of water). The result is expressed in seconds that are frequently referred to as Gurley Seconds. A product with a Gurley Hill number of 4 sec will have twice the porosity as one with a Gurley Hill number of 8 sec and will be twice as breathable for the wearer's comfort.

SOFTNESS of the product is measured with a “Handle-O-Meter” tester (Model number 211-5) manufactured by Thwing Albert Instrument Company, of Philadelphia, Pa., USA. A square measuring 102 mm by 102 mm (4 inch by 4 inch) is placed over a 10 mm slot in the machine where the sample is arranged such that ⅓ of the sample is past the slot towards the 2 mm thick measuring arm. The arm presses the sample into the fixed slot and records the maximum force in grams, which is recorded as the measure of the material's softness. Since the measurement is of the force to press the sample into the slot, a lower number indicates a softer product.

SURFACE ABRASION RESISTANCE of the product is measured with a A.A.T.C.C. Crockmeter from Atlas Electric Devices Company. The A.A.T.C.C. Crockmeter is a standard instrument of the American Association of Textile Chemists and Colorists. A sample size of 25.4 cm×5.08 cm (10 in.×2 in) is secured to the A.A.T.C.C. Crockmeter base where a ⅝″ OD piece of Eberhard Faber 101, double beveled, Pink Pearl eraser contacts the sample's surface. The eraser is traversed back and forth along the surface of the product, applying 900 grams (32 oz) of abrasion force per stroke until the surface is penetrated. The amount of strokes required to penetrate the surface is recorded as the measure of surface abrasion resistance. A product with a greater number of strokes indicates a product with a higher resistance to surface abrasion.

### EXAMPLES

Pertinent properties of both control and inventive samples 1-5 are given in Table 1.

### Example 1

(Control) is a current commercial Tyvek® product spun from hydrocarbon solvent that is bonded with a linen pattern (surface bond) on one side of the sheet and a rib (point bond) pattern on the other side at bonding speeds of between about 256 to 284 m/min (8.4 to 9.4 milliseconds residence time) and bonding roll temperatures between about 174 and 177° C. for the two sides of the sheet.

### Example 2

(Control) is point bonded on both sides of the sheet according to the process of U.S. Pat. No. 4,910,075, as in Example 1 of said patent. The sheet is embossed on both sides with rolls having 30 bosses/cm², each with a cross-sectional area of 0.0016 cm² for a total bonded area of about 4.9% of the sheet. The points under the bosses are rendered translucent by the conditions of bonding which are a bonding temperature of 155° C. and a line speed of 30.5 m/min (22.3 to 31 milliseconds residence time).

### Example 3

(Control) is point bonded on both sides of the sheet according to the process of U.S. Pat. No. 4,091,137, as in Example 6, Sample “S” of said patent. The sheet is embossed on both sides with rolls having 43 bosses/cm², each with a cross-section of 0.0014 cm², for a total bonded area of about 12% of the sheet surface. The points under the bosses are fused by the conditions of bonding, which are bonding temperature of 156° C. and a line speed of 45.7 m/min (1.4 to 1.9 milliseconds residence time). The embossed regions of the product were bonded to a point of transparency to satisfy a required average optical transmission of at least 50%.

### Examples 4-6

Illustrate typical products of this invention using a rib-by-rib embossing roll pattern, at a line speed of about 284 meters/min (about 9.4 milliseconds residence time).

TABLE 1
SAMPLE PROPERTIES

| | | | | | | | CROC** |
|---|---|---|---|---|---|---|---|
| | Bond temp | Bond Pressure | MD WTB | HH | GH | HOM* | (strokes) |
| Ex. No | (deg. C.) | (kN/m² of bond area) | (N-cm) | (cm) | (sec) | (grams) | (top/bottom) |
| 1 | 177/174 | 37-50 | 4.5 | 117 | 7.3 | 16.3 | 17/12 |
| | | (rib side only) | | | | | |
| 2 | 155 | 460-560 | — | 20 | <1 | — | — |
| 3 | 156 | >600 | — | — | 91 | — | — |
| 4 | 172/166 | 37-50 | 6.4 | 110 | 3.9 | 11.6 | 25/23 |
| 5 | 170/166 | 37-50 | 6.3 | 110 | 3.9 | 11.1 | 14/12 |
| 6 | 169/165 | 37-50 | 6.1 | 112 | 4.1 | — | 12/13 |

*Handle-O-Meter Softness, measured as an average of MD and CD softness values.
**Surface abrasion resistance as measured by A.A.T.C.C. Crockmeter.

It can be clearly seen from these results that the products of this invention have a superior balance of properties for barrier sheet applications such as protective apparel or operating room drapes, having both improved breathability and toughness over the current commercial Tyvek® sheet of Example 1 and significantly better resistance to liquid penetration than the product of U.S. Pat. No. 4,910,075 (Example 2). It is believed that the reason for the improved properties of the sheets of the present invention, as compared to the current commercial product is the use of point bonds for both sides of the sheet, since the linen bonded side of the commercial product, which is bonded over the whole surface, restricts both breathability of the sheet and freedom of movement of the individual film-fibrils. The added freedom of movement of the inventive sheet that is point bonded on both sides results in the increased toughness and also significant improvement in softness.

It is also believed that the improved Hydrostatic Head properties of the sheet of the current invention, as compared to the two-side point bonded product of U.S. Pat. No. 4,910,075 (Example 2), is due to the increased bonding area, coupled with less severe bonding conditions (combination of temperature, pressure and residence time) which result in the bond points not being melted to the point of translucency.

It is evident that the plexifilamentary film-fibril sheets of the present invention (Examples 4-6) demonstrate significantly improved breathability over the severely bonded sheets of U.S. Pat. No. 4,091,137 (Example 3).

It is also believed that the product of the present invention will provide desirable characteristics to bedding linen applications. Specifically, the sheet products according to the present invention demonstrate the ability to impede the progress of dust mites through the bedding material. Recently, increasing attention has been focussed on the allergic effects of dust mites on humans. In order to protect consumers from allergens in their bed such as dust mites and their decrements, the nonwoven sheets of this invention can be used as a barrier fabric in the form of mattress covers and pillow covers. The nonwoven sheet of this invention possesses desirable properties for this application due to its soft and breathable characteristics, while also providing particle barrier protection.

### Example 7

Particle challenge testing was performed on the nonwoven sheets of this invention and another commercial product in this market. Example 7 is a typical sample of the nonwoven sheet of the invention, made using conditions that fall within the range of conditions used in Examples 4-6.

### Example 8

(Comparison) is a representative commercial allergen barrier material used in bedding applications which is made from a microfiber woven fabric and sold by Allergy Control Products, Inc. (Ridgefield, Conn.) under the tradename Pristine® 100. The particular product tested was a Queen size Pristine® 100 pillow cover, Item #PRPQ. The results are shown in Table 2. These results show that the filtration efficiency of the nonwoven sheets of the present invention is significantly higher than that of the control.

TABLE 2
SAMPLE PROPERTIES
Filtration Efficiency

Particle Size Range (microns)

| | 0.5-0.7 | 0.7-1.0 | 1.0-2.0 | 2.0-3.0 |
|---|---|---|---|---|
| Example 7 | 99.20% | 99.80% | >99.9% | >99.9% |
| Example 8 | 4.51% | 6.83% | 19.05% | 52.98% |

We claim:

1. A process for preparing a nonwoven sheet comprising point bonding the sheet on both sides by passing said sheet between embossing rolls at a combination of bonding temperature, pressure and residence time such that the majority of bond points are not bonded to the point of translucency.

2. The process of claim 1, wherein a cross-sectional area of point bonding on each side of said sheet is from about 10-20% of the sheet area.

3. The process of claim 1, wherein each of said embossing rolls has from 50-80 bosses/cm².

4. The process of claim 2, wherein and the cross-sectional area of bonding on each side of said sheet is from about 13-17% of the sheet area.

5. The process of claim 3, wherein said embossing rolls have from 60-70 bosses/cm.

6. The process of claim 1, wherein the bonding pressure is from about 5-75 kN/m² of bonded area.

7. The process of claim 1, wherein the residence time of a boss on said sheet is less than 55 milliseconds.

8. A nonwoven sheet material which has been point bonded on both sides of said sheet, wherein the bond points are not bonded to the point of translucency.

9. The nonwoven sheet of claim 8, wherein bond points encompass about 10-20% of the area of each side of the sheet.

10. The nonwoven sheet of claim 8, which is a flash spun film-fibril sheet having a Gurley Hill porosity of less than about 4.5 sec and a hydrostatic head of at least about 100 cm.

11. The nonwoven sheet of claim 8, having Handle-O-Meter softness of no greater than about 12 grams.

12. The nonwoven sheet of claim 8, that has from 50-80 bond points/cm² on each side of said sheet.

13. The nonwoven sheet of claim 8, having from 60-70 bond points/cm² on each side of said sheet, said bond points on each side of said sheet encompassing about 13-17% of the area of the sheet.

14. The nonwoven sheet of claim 10, which has a work to break of at least about 5 N-cm.

15. The nonwoven sheet of claim 8, having a ribbed point bonding pattern on both sides of the sheet.

16. A nonwoven sheet made by a process comprising point bonding the sheet on both sides by passing said sheet between embossing rolls at a combination of bonding temperature, pressure and residence time such that the majority of bond points are not bonded to the point of translucency.

17. The nonwoven sheet of claim 16, wherein a cross-sectional area of point bonding on each side of said sheet is from about 10-20% of the sheet area.

18. The nonwoven sheet of claim 17, which is a flash spun film-fibril sheet having a Gurley Hill porosity of less than about 4.5 sec and a hydrostatic head of at least about 100 cm.

19. The nonwoven sheet of claim 18, having Handle-O-Meter softness of no greater than about 12.

20. The nonwoven sheet of claim 19, which has a work to break of at least about 5 N-cm.

21. A bed linen material made of a nonwoven sheet according to claim 8.

22. An article of protective apparel made of a nonwoven sheet according to claim 8.

23. An operating room drape made of a nonwoven sheet according to claim 8.

24. The nonwoven sheet according to claim 8, which has a A.A.T.C.C. Crockmeter surface stability greater than 10 strokes.
